(19) United States
(12) Patent Application Publication
(10) Pub. No.: US 2016/0155384 A1
(43) Pub. Date: Jun. 2, 2016

(54) ORGANIC LIGHT-EMITTING DIODE (OLED) DISPLAY, DISPLAY SYSTEM INCLUDING THE SAME AND METHOD OF DRIVING THE SAME

(71) Applicant: Samsung Display Co., Ltd., Yongin-city (KR)

(72) Inventors: Seong-Kyun KIM, Seoul (KR); So-Young KIM, Seoul (KR); Dong-Hak PYO, Hwaseong-si (KR)

(21) Appl. No.: 14/699,364

(22) Filed: Apr. 29, 2015

(30) Foreign Application Priority Data
Dec. 1, 2014 (KR) 10-2014-0169700

(51) Int. Cl. G09G 3/32

(52) U.S. Cl. CPC G09G 3/3258; G09G 2320/041; G09G 2320/0285; G09G 2310/08

(57) ABSTRACT

An organic light-emitting diode (OLED) display, display system including the same and method of driving the same are disclosed. In one aspect, the OLED display includes a display panel including a plurality of pixels arranged on a front surface of the panel and a plurality of temperature sensors arranged on a rear surface of the panel. The temperature sensors are configured to output a plurality of sensed temperature signals. The OLED display further includes a timing controller including a memory configured to store a temperature model look-up table (LUT). The timing controller is configured to convert the sensed temperature signals using the temperature model LUT, calculate a compensation coefficient based on the converted temperature signals and compensate image data based on the calculated compensation coefficient. The temperature model LUT is configured to nonlinearly map the sensed temperature signals to the converted temperature signals.

### INCORPORATION BY REFERENCE TO ANY PRIORITY APPLICATIONS

This application claims priority under 35 U.S.C. §119 to Korean Patent Application No. 10-2014-0169700 filed on Dec. 1, 2014, the disclosure of which is hereby incorporated by reference herein in its entirety.

### BACKGROUND

1. Field

The described technology generally relates to organic lighting-emitting diode (OLED) displays, display systems including the same and methods of driving the same.

2. Description of the Related

Various kinds of flat panel displays having reduced weight and volume have been developed. Flat panel displays can be categorized based on their display technology into liquid crystal displays (LCDs), field emission displays (FEDs), plasma display panels (PDPs), OLED displays, etc. OLED displays have advantages over the other display types including fast response speeds and low power consumption.

OLED displays generate heat while driving data and increased temperatures influence overall luminance. In addition, endurance of the panel may be degraded due to the heat.

### SUMMARY OF CERTAIN INVENTIVE ASPECTS

One inventive aspect is and OLED display having an improved performance.

Another aspect is a display system including an OLED display having an improved performance.

Another aspect is a method of driving an OLED display having an improved performance.

Another aspect is an OLED display including a display panel, a data driver and a timing controller. The display panel includes a front surface and a rear surface opposing the front surface, a plurality of pixels are arranged in the front surface, a plurality of temperature sensors are arranged in the rear surface, and each of the temperature sensors is arranged at each corresponding position of reference pixels of the plurality of pixels. The data driver outputs data voltages to data lines connected to the pixels and the data voltages corresponds to data signal. The timing controller controls the data driver, converts sensed temperature signals from the temperature sensors using a temperature model look-up table (LUT), calculates a compensation coefficient based on the converted temperature signals and compensates image data based on the calculated compensation coefficient to provide the data signal. The temperature model LUT nonlinearly maps the sensed temperature signals to the converted temperature signals.

In exemplary embodiments, the OLED display can further include a scan driver and a power supply. The scan driver can output scan signals to scan lines connected to the pixels. The power supply can provide the display panel with a high power supply voltage and a low power supply voltage. The timing controller can further control the scan driver and the power supply.

Each of the pixels can include a switching transistor that has a first terminal connected to each of the data lines, a gate terminal connected to each of the scan lines and a second terminal connected to a first node, a storage capacitor connected between the high power supply voltage and the first node, a driving transistor that has a first terminal connected to the high power supply voltage, a gate terminal connected to the first node and a second terminal and an OLED connected between the second terminal of the driving transistor and the lower power supply voltage.

In exemplary embodiments, the timing controller can include a data compensation circuit that converts the image data to the data signal based on the sensed temperature signals.

The data compensation circuit can include a memory, a temperature converter, an interpolator, a compensation coefficient calculator and a data converter. The memory can store the temperature model LUT. The temperature converter can convert the sensed temperature signal to the converted temperature signals by referring to the temperature model LUT. The interpolator can interpolate the converted temperature signals based on a first clock signal and a second clock signal to provide a temperature data of each pixel, and the first clock signal and the second clock signal can represent a position of the each pixel. The compensation coefficient calculator can calculate a compensation coefficient used for compensating the image data, based on the temperature data. The data converter can convert the image data to the data signal on a pixel-by-pixel basis based on the compensation coefficient.

When the temperature model LUT does not include the sensed temperature signals, the temperature converter can interpolate two sensed temperature signals in the temperature model LUT, which are adjacent to each of the sensed temperatures signals, to provide corresponding converted temperature signals.

The front surface can be divided into a plurality of display regions based on positions of the reference pixels. The interpolator can calculate a temperature data of each pixel based on relative distances from each pixel in each display region to each some of the reference pixels and each some of the reference pixels define each display region.

The interpolator can interpolate a temperature data of each some of the reference pixels based on the relative distance to provide the temperature data of each pixel.

The data converter can multiply the image data by the compensation coefficient on a pixel-by-pixel basis to provide the data signal.

In exemplary embodiments, the converted temperature signal can represent a target luminance of a corresponding pixel at a corresponding sensed temperature signal.

In exemplary embodiments, each of the temperature sensors can include a thermistor that has a negative temperature coefficient.

In exemplary embodiments, the plurality of reference pixels can include a first reference pixel connected to a first data line of the data lines and a first scan line of the scan lines; a second reference pixel connected to a last data line of the data lines and the first scan line; a third reference pixel connected to the first data line and a last scan line of the scan lines; a fourth reference pixel connected to the last data line and the last scan line; a fifth reference pixel connected to the first scan line and arranged at a substantially same distance from the first and second reference pixels; a sixth reference pixel connected to the last scan line and arranged at a substantially same distance from the third and fourth reference pixels; a seventh reference pixel connected to the first data line and arranged at a substantially same distance from the first and third reference pixels; an eighth reference pixel connected to the last data line and arranged at a substantially same distance from the second and fourth reference pixels; and a ninth reference pixel connected to a same data line to which the seventh reference pixel is connected, and arranged at a substantially same distance from the seventh and eighth reference pixels.

Another aspect is a display system includes a display panel, a display driver integrated circuit (DDI) an application processor. The display panel includes a front surface and a rear surface opposing the front surface, a plurality of pixels are arranged in the front surface, a plurality of temperature sensors are arranged in the rear surface, and each of the temperature sensors is arranged at each corresponding position of reference pixels of the plurality of pixels. The DDI processes image data to generate a data signal and configured to provide the display panel with a data voltage corresponding to the data signal. The application processor provide the DDI with the image data and control signals associated with the image data, converts sensed temperature signals from the temperature sensors using a temperature model look-up table (LUT) and provides the converted temperature signals to the DDI.

In exemplary embodiments, the DDI can include a data driver and a timing controller. The data driver can output the data voltage corresponding to the data signal to data lines connected to the pixels. The timing controller can control the data driver, configured to calculate a compensation coefficient based on the converted temperature signals and configured to compensate the image data based on the calculated compensation coefficient to provide the data signal.

Each of the pixels can include a switching transistor that has a first terminal connected to each of the data lines, a gate terminal connected to each of the scan lines and a second terminal connected to a first node, a storage capacitor connected between the high power supply voltage and the first node, a driving transistor that has a first terminal connected to the high power supply voltage, a gate terminal connected to the first node and a second terminal and an OLED connected between the second terminal of the driving transistor and the lower power supply voltage.

The timing controller can include a data compensation circuit. The data compensation circuit can convert the image data to the data signal based on the converted temperature signals. The data compensation circuit can include an interpolator, a compensation coefficient calculator and a data converter. The interpolator can interpolate the converted temperature signals based on a first clock signal and a second clock signal to provide a temperature data of each pixel, and the first clock signal and the second clock signal can represent a position of the each pixel. The compensation coefficient calculator can calculate a compensation coefficient used for compensating the image data, based on the temperature data. The data converter can convert the image data to the data signal on a pixel-by-pixel basis based on the compensation coefficient.

The data converter can multiply the image data by the compensation coefficient on a pixel-by-pixel basis to provide the data signal.

In exemplary embodiments, the application processor can include a memory and a temperature converter. The memory can store the temperature model LUT. The temperature converter can convert the sensed temperature signal to the converted temperature signals by referring to the temperature model LUT.

In exemplary embodiments, the converted temperature signal can represent a target luminance of a corresponding pixel at a corresponding sensed temperature signal.

Another aspect is a method of driving data in an OLED display including sensing temperatures at a plurality of reference positions using a plurality of temperature sensors to generate temperature signals, in a display panel including a front surface and a rear surface opposed to the front surface. A plurality of pixels are arranged in the front surface and the plurality of temperature sensors are arranged in the rear surface. The sensed temperature signals are converted using a temperature model look-up table (LUT), and the temperature model LUT nonlinearly maps the sensed temperature signals to the converted temperature signals. A compensation coefficient is calculated based on the converted temperature signals. Image data from an application processor is converted to a data signal based on the compensation coefficient. The data signal provided to a data driver to output data voltage corresponding to the data signal to the display panel.

Another aspect is an OLED display comprising a display panel including a front surface and a rear surface opposing the front surface, wherein the display panel further includes: i) a plurality of pixels arranged on the front surface, ii) a plurality of temperature sensors arranged on the rear surface and iii) a plurality of data lines electrically connected to the pixels, wherein the pixels include a plurality of reference pixels, wherein the temperature sensors are respectively formed at positions corresponding to the reference pixels and wherein the temperature sensors are configured to: i) sense a plurality of temperatures and ii) output a plurality of sensed temperature signals indicative of the sensed temperatures; a data driver configured to output data voltages to the data lines, wherein the data voltages correspond to a data signal; and a timing controller comprising a memory configured to store a temperature model look-up table (LUT), wherein the timing controller is configured to: i) control the data driver, ii) convert the sensed temperature signals using the temperature model LUT, iii) calculate at least one compensation coefficient based on the converted temperature signals and iv) compensate image data based on the calculated compensation coefficient so as to generate the data signal, and wherein the temperature model LUT is configured to nonlinearly map the sensed temperature signals to the converted temperature signals.

In exemplary embodiments, the display panel further comprises a plurality of scan lines electrically connected to the pixels, wherein the OLED display further comprises a scan driver configured to sequentially output a plurality of scan signals to the scan lines; and a power supply configured to provide the display panel with a high power supply voltage and a low power supply voltage, wherein the timing controller is further configured to control the scan driver and the power supply.

In exemplary embodiments, each of the pixels comprises a switching transistor including: i) a first terminal electrically connected to a corresponding one of the data lines, ii) a gate terminal electrically connected to a corresponding one of the scan lines, and iii) a second terminal electrically connected to a first node; a storage capacitor electrically connected between the high power supply voltage and the first node; a driving transistor including: i) a first terminal electrically connected to the high power supply voltage, ii) a gate terminal electrically connected to the first node and iii) a second terminal; and an OLED electrically connected between the second terminal of the driving transistor and the lower power supply voltage.

In exemplary embodiments, the timing controller comprises a data compensation circuit configured to convert the image data into the data signal based on the sensed temperature signals.

In exemplary embodiments, the data compensation circuit comprises the memory; a temperature converter configured to convert the sensed temperature signals into the converted temperature signals based on the temperature model LUT; an interpolator configured to interpolate the converted temperature signals based on a first clock signal and a second clock signal so as to generate a temperature data for each of the pixels, wherein the first clock signal and the second clock signal represent the positions of the pixels; a compensation coefficient calculator configured to calculate the compensation coefficient based on the temperature data; and a data converter configured to convert the image data into the data signal based on the compensation coefficient.

In exemplary embodiments, when the temperature model LUT does not include a first one of the sensed temperature signals, the temperature converter is configured to interpolate the first sensed temperatures signal based on two sensed temperature signals that are in the temperature model LUT so as to generate a first converted temperature signal, wherein the two sensed temperature signals are adjacent to the first sensed temperature signal.

In exemplary embodiments, the front surface is divided into a plurality of display regions based on the positions of the reference pixels and wherein the interpolator is further configured to calculate the temperature data for a first one of the pixels based on the distances from the first pixel in the corresponding display region to the nearest reference pixels.

In exemplary embodiments, the data converter is further configured to multiply the image data by the compensation coefficient so as to generate the data signal.

In exemplary embodiments, each of the converted temperature signals represents a target luminance of a corresponding one of the pixels for a corresponding one of the sensed temperature signals.

In exemplary embodiments, each of the temperature sensors includes a thermistor that has a negative temperature coefficient.

In exemplary embodiments, the reference pixels comprise a first reference pixel electrically connected to a first one of the data lines and a first one of the scan lines; a second reference pixel electrically connected to a last one of the data lines and the first scan line; a third reference pixel electrically connected to the first data line and a last one of the scan lines; a fourth reference pixel electrically connected to the last data line and the last scan line; a fifth reference pixel electrically connected to the first scan line and arranged at substantially the same distance from each of the first and second reference pixels; a sixth reference pixel electrically connected to the last scan line and arranged at substantially the same distance from each of the third and fourth reference pixels; a seventh reference pixel electrically connected to the first data line and arranged at substantially the same distance from each of the first and third reference pixels; an eighth reference pixel electrically connected to the last data line and arranged at substantially the same distance from each of the second and fourth reference pixels; and a ninth reference pixel electrically connected to the same data line to which the seventh reference pixel is connected and arranged at substantially the same distance from each of the seventh and eighth reference pixels.

Another aspect is a display system comprising a display panel including: i) a front surface and a rear surface opposing the front surface, ii) a plurality of pixels arranged on the front surface and iii) a plurality of temperature sensors arranged on the rear surface, wherein the pixels include a plurality of reference pixels, wherein the temperature sensors are respectively arranged at positions corresponding to the reference pixels and wherein the temperature sensors are configured to: i) sense a plurality of temperatures and ii) output a plurality of sensed temperature signals indicative of the sensed temperatures; a display driver integrated circuit (DDI) configured to: i) process image data so as to generate a data signal and ii) provide the display panel with a data voltage corresponding to the data signal; and an application processor comprising a memory storing a temperature model look-up table (LUT), wherein the application processor is configured to: i) provide the DDI with the image data and control signals associated with the image data, ii) convert the sensed temperature signals using the temperature model LUT and iii) provide the converted temperature signals to the DDI, wherein the temperature model LUT is configured to nonlinearly map the sensed temperature signals to the converted temperature signals.

In exemplary embodiments, the DDI comprises a plurality of data lines electrically connected to the pixels; a data driver configured to output the data voltage to data lines; and a timing controller configured to: i) control the data driver, ii) calculate at least one compensation coefficient based on the converted temperature signals and iii) compensate the image data based on the calculated compensation coefficient so as to generate the data signal.

In exemplary embodiments, the DDI further comprises a plurality of scan lines electrically connected to the pixels; and a power supply configured to supply a high power supply voltage and a low power supply voltage to the pixels, wherein each of the pixels comprises: a switching transistor including: i) a first terminal electrically connected to a corresponding one of the data lines, ii) a gate terminal electrically connected to a corresponding one of the scan lines and iii) a second terminal electrically connected to a first node; a storage capacitor electrically connected between the high power supply voltage and the first node; a driving transistor including: a first terminal electrically connected to the high power supply voltage, ii) a gate terminal electrically connected to the first node and iii) a second terminal; and an organic light-emitting diode (OLED) electrically connected between the second terminal of the driving transistor and the lower power supply voltage.

In exemplary embodiments, the timing controller comprises a data compensation circuit configured to convert the image data to the data signal based on the converted temperature signals and wherein the data compensation circuit comprises an interpolator configured to interpolate the converted temperature signals based on a first clock signal and a second clock signal so as to generate a temperature data for each of the pixels, wherein the first clock signal and the second clock signal represent the positions of the pixels; a compensation coefficient calculator configured to calculate the compensation coefficient based on the temperature data; and a data converter configured to convert the image data into the data signal based on the compensation coefficient.

In exemplary embodiments, the data converter is further configured to multiply the image data by the compensation coefficient so as to generate the data signal.

In exemplary embodiments, the application processor comprises a temperature converter configured to convert the sensed temperature signals into the converted temperature signals based on the temperature model LUT.

In exemplary embodiments, each of the converted temperature signals represents a target luminance of a corresponding one of the pixels for a corresponding one of the sensed temperature signals.

Another aspect is a method of driving an OLED display comprising sensing temperatures at a plurality of reference positions using a plurality of temperature sensors so as to generate a plurality of temperature signals, wherein the OLED display comprises a display panel including: i) a front surface, ii) a rear surface opposing the front surface, iii) a plurality of pixels arranged on the front surface, iii) the temperature sensors arranged in the rear surface and iv) a data driver; converting the sensed temperature signals using a temperature model look-up table (LUT), wherein the temperature model LUT is configured to nonlinearly map the sensed temperature signals to the converted temperature signals; calculating at least one compensation coefficient based on the converted temperature signals; converting image data to a data signal based on the compensation coefficient; and the data driver driving the pixels based on the data signal.

Accordingly, according to at least one embodiment, an OLED display includes a display panel and a timing controller. The display panel can include a front surface and a rear surface opposing the front surface, a plurality of pixels are arranged in the front surface, a plurality of temperature sensors are arranged in the rear surface and each of the temperature sensors is arranged at each corresponding position of reference pixels of the plurality of pixels. The timing controller can include a data compensation circuit. The data compensation circuit can convert sensed temperature signals from the temperature sensors using a temperature model LUT, can calculate a compensation coefficient based on the converted temperature signals and can compensate image data based on the calculated compensation coefficient to provide the data signal. The temperature model LUT can nonlinearly map the sensed temperature signals to the converted temperature signals. Therefore, data compensation can be accurately performed according to changes of temperature of the display panel.

### BRIEF DESCRIPTION OF THE DRAWINGS

Exemplary embodiments can be understood in more detail from the following description taken in conjunction with the accompanying drawings, in which:

FIG. 1 is a block diagram illustrating a display system according to example embodiments.

FIG. 2 is a block diagram illustrating the application processor of FIG. 1 according to example embodiments.

FIG. 3 is a block diagram illustrating the OLED display of FIG. 1 according to example embodiments.

FIG. 4 is a circuit diagram illustrating one of the pixels included in the display panel according to example embodiments.

FIG. 5 illustrates the structure of the display panel in FIG. 3 according to example embodiments.

FIG. 6 is a block diagram illustrating the data compensation circuit of FIG. 3 according to example embodiments.

FIG. 7 illustrates an example of the temperature model look-up table of FIG. 6 according to example embodiments.

FIG. 8 illustrates a relationship between the temperature and the compensation coefficient.

FIG. 9 illustrates compensation coefficients based on the (non-linear) temperature model LUT and compensation coefficients based on the standard temperature model.

FIG. 10 is a block diagram illustrating a display system according to example embodiments.

FIG. 11 is a block diagram illustrating the OLED display of FIG. 10 according to example embodiments.

FIG. 12 is a block diagram illustrating the data compensation circuit of FIG. 11 according to example embodiments.

FIG. 13 is a diagram for describing an example of the operation of the OLED display of FIG. 3.

FIG. 14 is a diagram for describing another example of the operation of the OLED display of FIG. 3.

FIG. 15 is a flow chart illustrating a method of driving data in an OLED display according to example embodiments.

FIG. 16 is a block diagram illustrating a mobile device according to example embodiments.

FIG. 17 is a block diagram illustrating an electronic system including an OLED display according to example embodiments.

### DETAILED DESCRIPTION OF CERTAIN INVENTIVE EMBODIMENTS

Exemplary embodiments are described more fully hereinafter with reference to the accompanying drawings. The described technology may, however, be embodied in many different forms and should not be construed as limited to the embodiments set forth herein. In the drawings, the sizes and relative sizes of layers and regions may be exaggerated for the sake of clarity.

It will be understood that when an element or layer is referred to as being “on,” “connected to” or “coupled to” another element or layer, it can be directly on, connected or coupled to the other element or layer or intervening elements or layers may also be present. In contrast, when an element is referred to as being “directly on,” “directly connected to” or “directly coupled to” another element or layer, there are no intervening elements or layers present. Like or similar reference numerals refer to like or similar elements throughout. As used herein, the term “and/or” includes any and all combinations of one or more of the associated listed items.

It will be understood that, although the terms first, second, third etc. may be used herein to describe various elements, components, regions, layers, patterns and/or sections, these elements, components, regions, layers, patterns and/or sections should not be limited by these terms.

The terminology used herein is for the purpose of describing particular example embodiments only and is not intended to be limiting of the described technology. As used herein, the singular forms “a,” “an” and “the” are intended to include the plural forms as well, unless the context clearly indicates otherwise. It will be further understood that the terms “comprises” and/or “comprising,” when used in this specification, specify the presence of the stated features, integers, steps, operations, elements, and/or components, but do not preclude the presence or addition of one or more other features, integers, steps, operations, elements, components, and/or groups thereof.

Example embodiments are described herein with reference to cross sectional illustrations that are schematic illustrations of illustratively idealized example embodiments (and intermediate structures) of the described technology. As such, variations from the shapes of the illustrations as a result, for example, of manufacturing techniques and/or tolerances, are to be expected. Thus, the example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the described technology.

Unless otherwise defined, all terms (including technical and scientific terms) used herein have the same meaning as commonly understood by one of ordinary skill in the art to which the described technology belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 1 is a block diagram illustrating a display system according to example embodiments.

Referring to FIG. 1, the display system (or image processing system) 10 includes an application processor (AP) 100, an external memory 50 and an OLED display 200. The OLED display 200 includes a display driving integrated circuit (DDI) 205 and a display panel 250.

In some embodiments, the AP 100 and the DDI 205 are implemented within one module, one system on chip or one package such as a multi-chip package. In other embodiments, the DDI 205 and the display panel 250 are implemented in separate modules.

The display system 10 can be implemented as a personal computer or a portable device. The portable device may include a laptop computer, a mobile phone, a smart phone, a table computer, a personal digital assistant (PDA), a portable multi-media player (PMP), a Moving Picture Experts Group (MPEP) Audio Layer III (MP3) player, or an automotive navigation system.

The AP 100 can control the external memory 50 and/or the OLED display 200. The external memory 50 stores display data to be displayed on the display panel 250.

The AP 100 provides the DDI 205 with image data RGB, control signals CTL associated with the image data RGB and a clock signal ECLK. The display panel 205 can provide the DDI 205 with sensed temperature signals ST representing the temperature of the display panel 250.

The DDI 205 processes the image data RGB according to the control signal CTL to output display data DDTA to the display panel 250. When the DDI 205 outputs the display data DDTA to the display panel 250, the DDI 205 can compensate the image data RGB based on the sensed temperature signals ST.

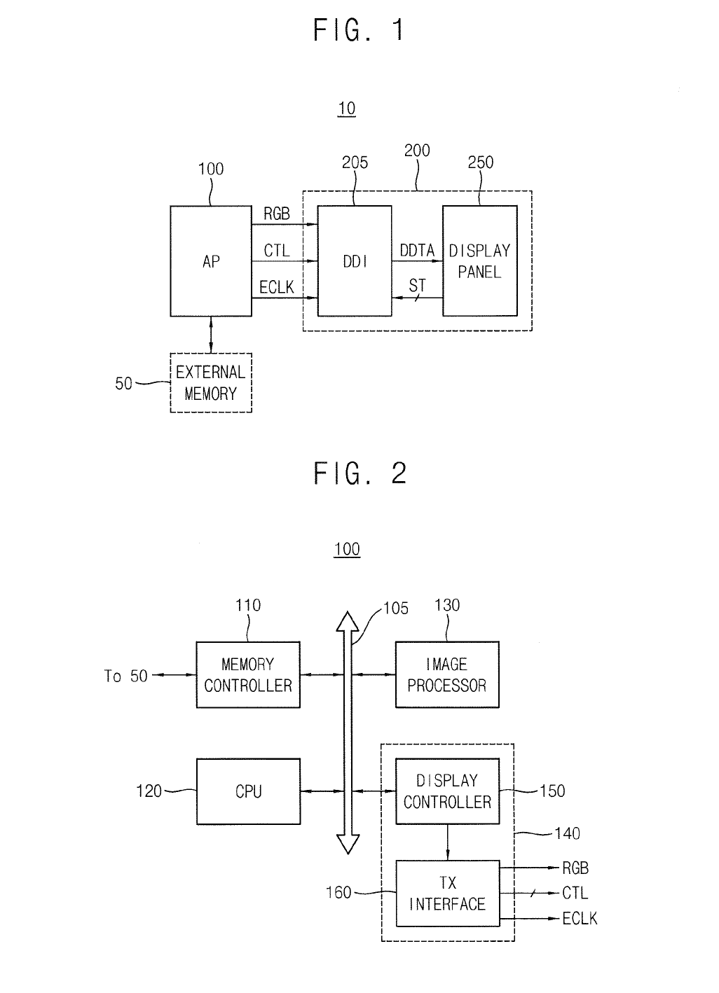

FIG. 2 is a block diagram illustrating the application processor of FIG. 1 according to example embodiments.

Referring to FIG. 2 the AP 100 includes a memory controller 110, a central processing unit (CPU) 120, an image processor 130 and a display block or display control module 140. The display block 140 includes a display controller 150 and a transmission (TX) interface 160. The memory controller 110, the CPU 120, the image processor 130 and the display block 140 can communicate with each other through a bus 105.

The memory controller 110 can control the external memory 50.

The CPU 120 can control the overall operation of the AP 100. The image data such as moving image data or still image data received from the external memory 50 can be transmitted to the display block 140 through the bus 105 according to the control of the CPU 120. The external memory 50 can be implemented with a volatile memory such as dynamic random access memory (DRAM) or a nonvolatile memory such as NAND flash memory. The CPU 120 can be implemented with a single core having one core or a multi-core having a plurality of cores.

The image processor 130 can process the image data from the external memory 50 and store the processed image data in the external memory 50 according to the control of the CPU 120.

The display controller 150 can control the transmission of the image data stored in the external memory 50 via the transmission interface 160.

The transmission interface 160 can transmit the image data RGB, the control signal CTL and the clock signal ECLK to the OLED display 200 according to the control of the display controller 150.

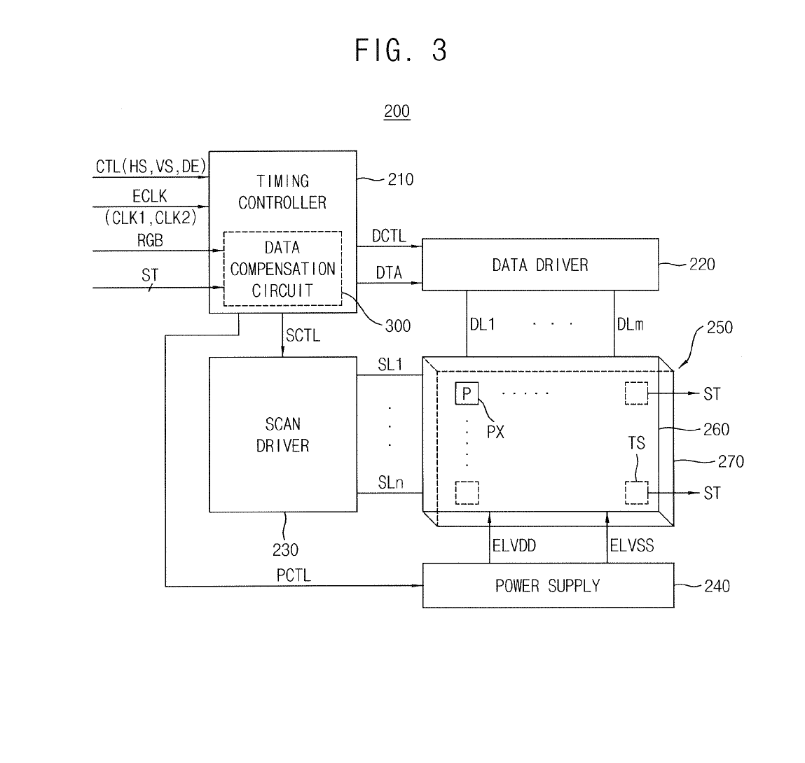

FIG. 3 is a block diagram illustrating the OLED display of FIG. 1 according to example embodiments.

Referring to FIG. 3, the OLED display 200 includes a timing controller 210, a data driver 220, a scan driver 230, a power supply 240 and a display panel 250.

The timing controller 210, the data driver 220 and the scan driver 230 may form the DDI 205 of FIG. 1.

The display panel 250 includes a front surface 260 and a rear surface 270 opposing the front surface 260. A plurality of pixels PX are arranged on the front surface 260. A plurality of temperature sensors TS are arranged on the rear surface 270. The temperature sensors TS can be formed at each corresponding position to reference pixels of the pixels PX.

The data driver 220 outputs data voltages (i.e., display data DDTA) corresponding to the data signal DTA to data lines DL1˜DLm (m is a natural number equal to or greater than two) connected to the pixels PX in response to a data control signal DCTL.

The scan driver 230 sequentially outputs scan signals to scan lines SL1˜SLn (n is a natural number equal to or greater than two) connected to the pixels PX in response to a scan control signal SCTL.

The power supply 240 provides the display panel 250 with a high power supply voltage ELVDD and a low power supply voltage ELVSS in response to a power control signal PCTL.

The timing controller 210 receives the image data RGB, the control signal CTL and the clock signal ECLK from the AP 100 of FIG. 1. The timing controller 210 can receive the sensed temperature signals ST from the display panel 250. The control signal CTL may include a horizontal synchronization signal HS, a vertical synchronization signal VS and a data enable signal DE. The clock signal ECLK may include a first clock signal CLK1 and a second clock signal CLK2.

The timing controller 210 can include a data compensation circuit 300 that compensates the image data RGB to output the data signal DTA, based on the sensed temperature signals ST, the first clock signal CLK1 and the second clock signal CLK2. The data compensation circuit 300 can convert the sensed temperature signals ST using a temperature model look-up table (LUT) that nonlinearly maps the sensed temperature signals ST. The data compensation circuit 300 can also calculate a compensation coefficient based on the converted temperature signals and compensate the image data RGB based on the calculated compensation coefficient to provide the data signal DTA. The timing controller 210 can generate the data control signal DCTL, the scan control signal SCTL and the power control signal PCTL based on the control signal CTL. The timing controller 210 can also provide the data control signal DCTL to the data driver 220, provide the scan control signal SCTL to the scan driver 230 and provide the power control signal PCTL to the power supply 240.

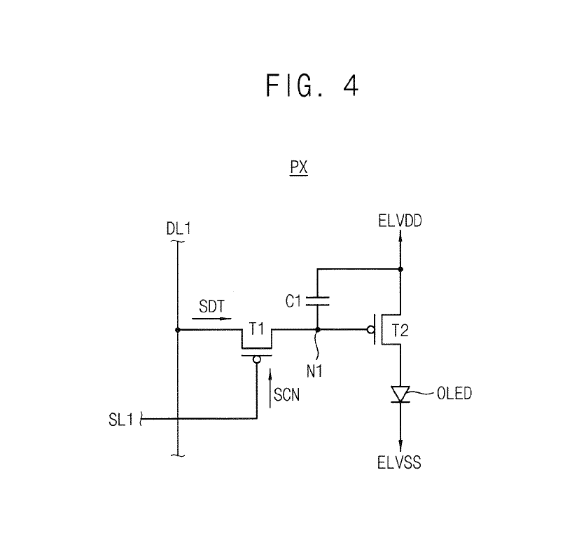

FIG. 4 is a circuit diagram illustrating one of the pixels included in the display panel according to example embodiments.

Referring to FIG. 4, the pixel PX includes a switching transistor T1, a driving transistor T2, a storage capacitor C1 and an OLED.

The switching transistor T1 can include a p-channel metal-oxide semiconductor (PMOS) transistor that has a first terminal connected to a data line DL1 to receive a data voltage SDT, a gate terminal connected to a scan line SL11 to receive a scan signal SCN and a second terminal connected to a first node N1. The driving transistor T2 can include a PMOS transistor that has a first terminal connected to a high power supply voltage ELVDD, a gate terminal connected to the first node N1 and a second terminal connected to a low power supply voltage ELVSS via the OLED. The storage capacitor C1 has a first terminal connected to the high power supply voltage ELVDD and a second terminal connected to the first node N1. The OLED has an anode electrode connected to the second terminal of the driving transistor T2 and a cathode electrode connected to the low power supply voltage ELVSS.

The switching transistor T1 transfers the data voltage SDT to the storage capacitor C1 in response to the scan signal SCN. The OLED emits light in response to the data voltage SDT stored in the storage capacitor C1 to display an image.

In example embodiments, the pixels PX of the display panel 250 can be driven in a digital driving method. In the digital driving method, the driving transistor T2 is operated as a switch in a linear region. Accordingly, the driving transistor T2 is operated in one of a turned-on state and a turned-off state.

To turn on or turn off the driving transistor T2, the data voltage SDT has two levels including a turn-on level and a turn-off level are used. In the digital driving method, a single frame is divided into a plurality of subfields to represent various grayscales via the turned-on and turned-off states of the driving transistor T2 in each of the subfields. The turned-on status and the turned-off status of the pixel during each of the subfields are combined so that the various grayscales can be represented.

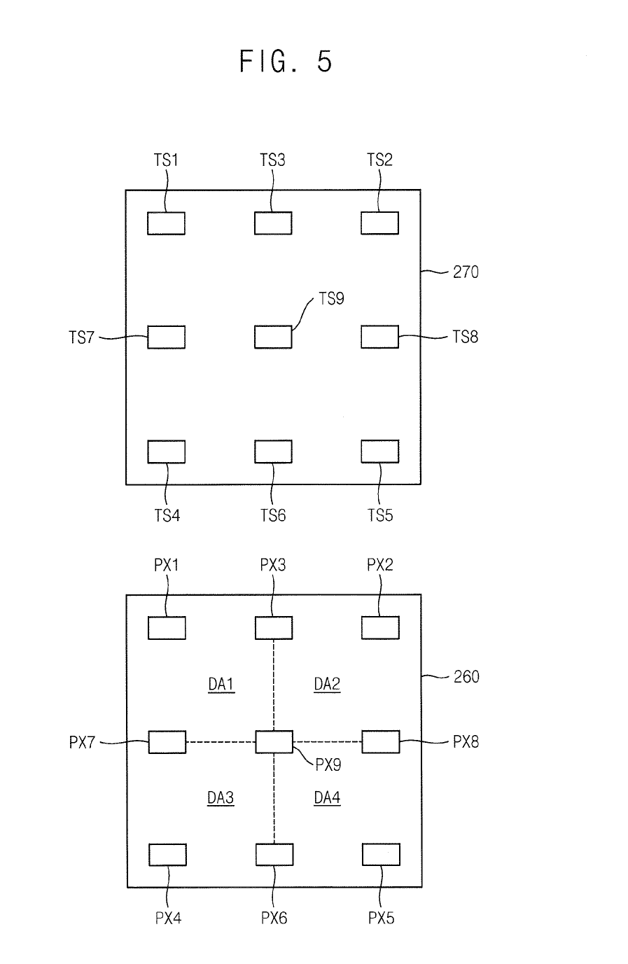

FIG. 5 illustrates a structure of the display panel in FIG. 3 according to example embodiments.

In FIG. 5, the front surface 260 and the rear surface 270 of the display panel 250 are separately illustrated.

Referring to FIGS. 3 and 5, a plurality of temperature sensors TS1˜TS9 are arranged at positions on the rear surface 270 corresponding to reference pixels PX1˜PX9 formed on the front surface 260. Each of the temperature sensors TS1˜TS9 can include a thermistor that has a negative temperature coefficient.

The reference pixel PX1 is connected to a first data line DL1 of the data lines DL1˜DLm and a first scan line SL1 of the scan lines SL1˜SLn. The reference pixel PX2 is connected to a last data line DLm of the data lines DL1˜DLm and the first scan line SL1. The reference pixel PX3 is connected to the first scan line SL1 and is arranged at substantially the same distance from each of the reference pixels PX1 and PX2.

The reference pixel PX4 is connected to the first data line DL1 and a last scan line SLn of the scan lines SL1˜SLn. The reference pixel PX5 is connected to the last data line DLm and the last scan line SLn. The reference pixel PX6 is connected to the last scan line SLn and is arranged at substantially the same distance from each of the reference pixels PX4 and PX5.

The reference pixel PX7 is connected to the first data line DL1 and is arranged at substantially the same distance from each of the reference pixels PX1 and PX4. The reference pixel PX8 is connected to the last data line DLm and is arranged at substantially the same distance from each of the reference pixels PX2 and PX5. The reference pixel PX9 is connected to the same scan line as reference pixels PX7 and PX8 and is arranged at substantially the same distance from each of the reference pixels PX7 and PX8.

Each of the temperature sensors TS1˜TS9 is arranged on the rear surface 270 at a corresponding position to the reference pixels PX1˜PX9.

The front surface 260 can be divided into a plurality of display regions DA1˜DA4 based on the positions of the reference pixels PX1˜PX9. The display region DA1 can be defined by the reference pixels PX1, PX3, PX7 and PX9. The display region DA2 can be defined by the reference pixels PX3, PX2, PX9 and PX8. The display region DA3 can be defined by the reference pixels PX7, PX9, PX4 and PX6. The display region DA4 can be defined by the reference pixels PX9, PX8, PX6 and PX5.

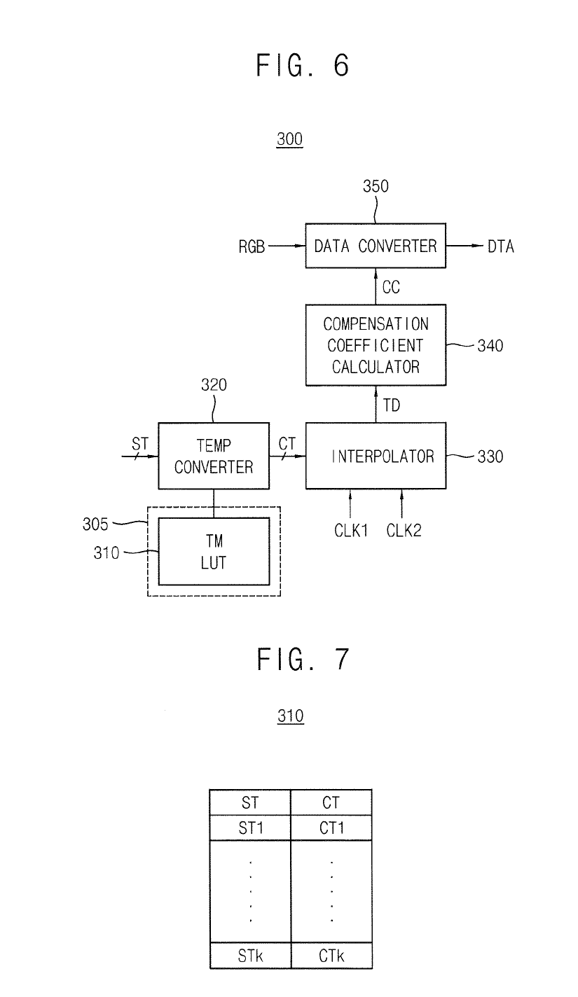

FIG. 6 is a block diagram illustrating the data compensation circuit of FIG. 3 according to example embodiments.

Referring to FIG. 6, the data compensation circuit 300 includes a memory 305, a temperature converter 320, an interpolator 330, a compensation coefficient calculator 340 and a data converter 350.

The memory 305 stores a temperature model (TM) LUT 310. The temperature converter 320 can convert the sensed temperature signals ST to converted temperature signals CT by referring to the temperature model LUT 310.

The interpolator 330 can interpolate the converted temperature signals CT based on the first clock signal CLK1 and the second clock signal CLK to provide temperature data TD for each pixel. The first clock signal CLK1 and the second clock signal CLK2 can represent the position of the pixel. The interpolator 330 can receive position information of each pixel based on the first clock signal CLK1 and the second clock signal CLK2 via counting each position of the pixel and can calculate the temperature data TD of each pixel by interpolating the temperature data TD of the reference pixels PX1˜PX9 based on the position information.

The compensation coefficient calculator 340 can calculate a compensation coefficient CC used for compensating the image data RGB based on the temperature data TD. The data converter 350 can convert the image data RGB to the data signal on a pixel-by-pixel basis based on the compensation coefficient CC by multiplying a luminance of the image data RGB by the compensation coefficient CC on a pixel-by-pixel basis to generate the data signal DTA.

When the sensed temperature signals ST are not included in the temperature model LUT 310, that is, when the sensed temperature signals ST do not match with entries in the temperature model LUT 310, the temperature converter 320 can interpolate the sensed temperature signals ST using two sensed temperature signals in the temperature model LUT 310 which are adjacent to each of the sensed temperature signals ST, to output a corresponding converted temperature signals CT. The interpolator 330 can generate the temperature data TD of each pixel based on the relative distances of the pixels in each of the display regions DA1˜DA4 from the reference pixels defining each of the display regions DA1˜DA4. The interpolator 330 can provide the temperature data TD of each pixel by interpolating the temperature data TD of each of the reference pixels defining each of the display regions DA1˜DA4 based on the relative distances.

FIG. 7 illustrates an example of the temperature model look-up table in FIG. 6 according to example embodiments.

Referring to FIG. 7, the temperature model LUT 310 stores the converted temperature signals CT1˜CTk (k is natural number greater than two) respectively corresponding to the sensed temperature signals ST1˜STk. That is, the temperature model

LUT 310 can nonlinearly map each of the sensed temperature signals ST1˜STk to each of the converted temperature signals CT1˜CTk. Each of the converted temperature signals CT1˜CTk can represent a target luminance of a corresponding pixel at a corresponding sensed temperature signal ST1˜STk.

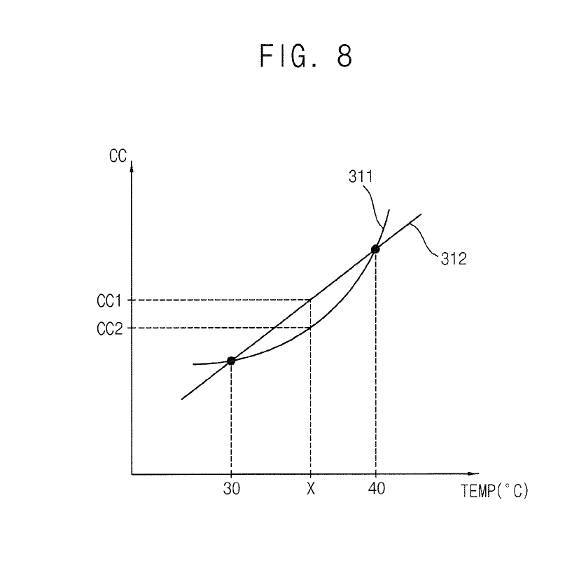

FIG. 8 illustrates a relationship between the temperature and the compensation coefficient.

In FIG. 8, a reference numeral 311 is a curve representing the relationship between the temperature and the compensation coefficient based on the temperature model LUT 311 according to example embodiments. Reference numeral 312 represents a linear relationship between the temperature and the compensation coefficient based on the standard temperature model. According to the standard model, when the temperature of the panel or a pixel corresponds to X, a compensation coefficient CC1 is calculated by interpolating two compensation coefficients at 30° C. and 40° C. However, according to example embodiments, a compensation coefficient CC1 is calculated based on the curve 311.

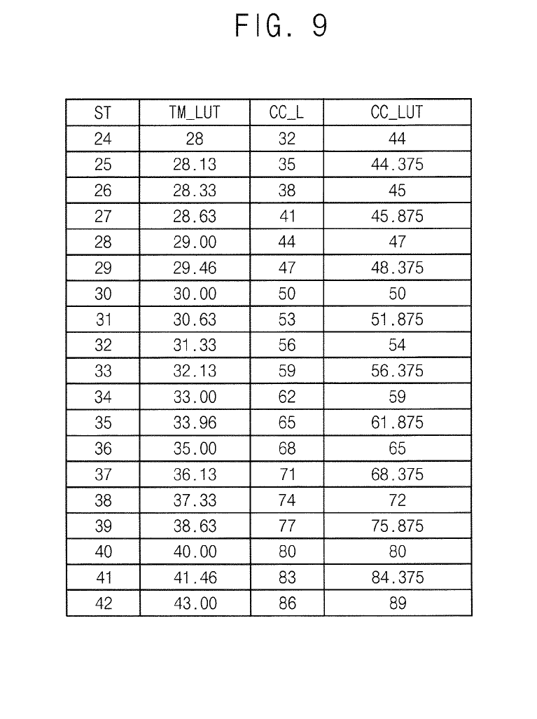

FIG. 9 illustrates compensation coefficients based on the (non-linear) temperature model LUT and compensation coefficients based on the standard temperature model.

In FIG. 9, ST denotes sensed temperature signals, TM_LUT denotes converted temperature signals in the temperature model LUT, corresponding to the sensed temperature signals, CC_L denotes compensation coefficients calculated based on the linear interpolation according to the standard temperature model and CC_LUT denotes compensation coefficients calculated based on the temperature model LUT. The standard temperature model may be represented as a linear equation represented by following equation 1 as indicated by the reference numeral 312 in FIG. 8, and the temperature model LUT may be represented as a second-order polynomial represented by following equation 2 as indicated by the reference numeral 311 in FIG. 8.

Y1=aX+b [Equation 1]

(where, X is sensed temperature, Y1 is converted temperature based on the standard temperature model, and a is a positive real number and b is non-zero real number).

Y2=cX²−dX+e [Equation 2]

(where, X is sensed temperature, Y2 is converted temperature based on the temperature model LUT, c, d and e are positive real numbers, d is greater than c and e is greater than d).

Referring to FIG. 9, it is noted that the compensation coefficients calculated based on the temperature model LUT are more accurate the compensation coefficients calculated based on the linear interpolation.

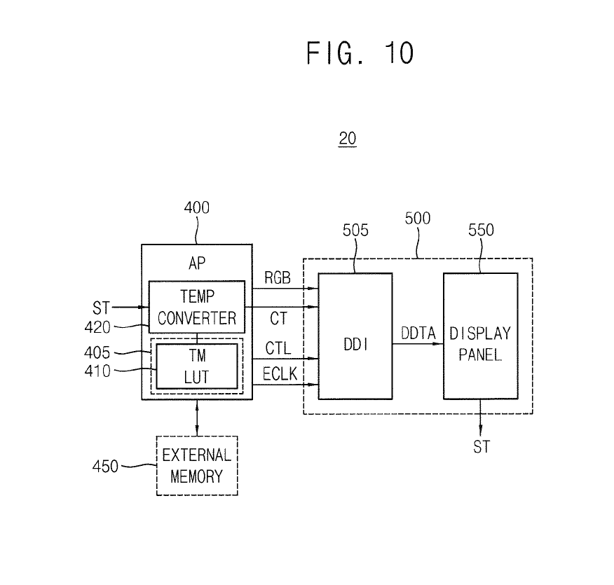

FIG. 10 is a block diagram illustrating a display system according to example embodiments.

Referring to FIG. 10, the display system (or image processing system) 20 includes an application processor (AP) 400, an external memory 450 and an OLED display 500. The OLED display 500 includes a display driving integrated circuit (DDI) 505 and a display panel 550.

In some embodiments, the AP 400 and the DDI 505 are implemented within one module, one system on chip or one package such as a multi-chip package. In other embodiments, the DDI 505 and the display panel 550 are implemented in separate modules.

The display system 20 can be implemented as a personal computer or a portable device. The portable device may include a laptop computer, a mobile phone, a smart phone, a table computer, a PDA, a portable multi-media player (PMP), an MP3 player, or an automotive navigation system.

The AP 400 can control the external memory 450 and/or the OLED display 500. The external memory 450 can store display data to be displayed in the display panel 450.

The AP 400 can provide the DDI 505 with image data RGB, control signals CTL associated with the image data RGB and a clock signal ECLK. The display panel 505 can provide the AP 400 with sensed temperature signals ST representing the temperature of the display panel 550.

The AP 400 includes a memory 405 and a temperature converter 420. The memory 405 stores a temperature model LUT 410. The temperature convert 420 can nonlinearly map the sensed temperature signal ST to converted temperature signals CT by referring to the temperature model LUT 410. The AP 400 can output the converted temperature signals CT to the DDI 505.

The DDI 505 can process the image data RGB according to the control signal CTL to output the display data DDTA to the display panel 550. When the DDI 505 outputs the display data DDTA to the display panel 550, the DDI 205 can compensate the image data RGB based on the converted temperature signals CT to output the display data DDTA to the display panel 550.

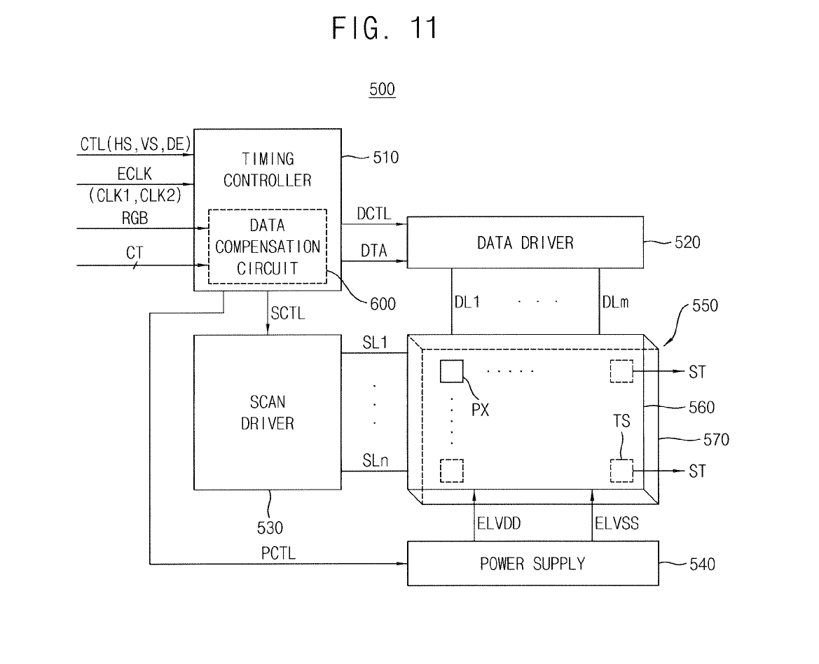

FIG. 11 is a block diagram illustrating the OLED display of FIG. 10 according to example embodiments.

Referring to FIG. 11, the OLED display 500 includes a timing controller 510, a data driver 520, a scan driver 530, a power supply 540 and the display panel 550.

The timing controller 510, the data driver 520 and the scan driver 530 may form the DDI 505 of FIG. 10.

The display panel 550 includes a front surface 560 and a rear surface 570 opposing the front surface 560. A plurality of pixels PX are arranged on the front surface 560. A plurality of temperature sensors TS are arranged on the rear surface 570. The temperature sensors TS are formed at positions corresponding to reference pixels of the pixels PX.

The data driver 520 can output data voltages (i.e., display data DDTA) corresponding to data signal DTA to data lines DL1˜DLm (m is a natural number equal to or greater than two) connected to the pixels PX in response to a data control signal DCTL.

The scan driver 530 can sequentially output scan signals to scan lines SL1˜SLn (n is a natural number equal to or greater than two) connected to the pixels PX in response to a scan control signal SCTL.

The power supply 540 can provide the display panel 550 with a high power supply voltage ELVDD and a low power supply voltage ELVSS in response to a power control signal PCTL.

The timing controller 510 can receive the image data RGB, the control signal CTL and the clock signal ECLK from the AP 500 in FIG. 10. The timing controller 510 can receive the sensed temperature signals ST from the display panel 550. The control signal CTL can include a horizontal synchronization signal HS, a vertical synchronization signal VS and a data enable signal DE. The clock signal ECLK can include a first clock signal CLK1 and a second clock signal CLK2.

The timing controller 510 includes a data compensation circuit 600 that compensates the image data RGB based on the converted temperature signals CT, the first clock signal CLK1 and the second clock signal CLK2 to output the data signal DTA. The data compensation circuit 600 can calculate a compensation coefficient based on the converted temperature signals CT and can compensate image data RGB based on the calculated compensation coefficient to provide the data signal DTA. The timing controller 510 can generate the data control signal DCTL, the scan control signal SCTL and the power control signal PCTL based on the control signal CTL. The timing controller 510 can provide the data control signal DCTL to the data driver 520, provide the scan control signal SCTL to the scan driver 530 and provide the power control signal PCTL to the power supply 540.

Each of the pixels PX can include the pixel PX configuration of FIG. 4.

In the display panel 550 a plurality of temperature sensors TS1˜TS9 are arranged positions corresponding to reference pixels PX1˜PX9 as described with reference to FIG. 5. Each of the temperature sensors TS1˜TS9 can include a thermistor that has a negative temperature coefficient.

FIG. 12 is a block diagram illustrating the data compensation circuit of FIG. 11 according to example embodiments.

Referring to FIG. 12, the data compensation circuit 600 includes an interpolator 630, a compensation coefficient calculator 640 and a data converter 650.

The interpolator 630 can interpolate the converted temperature signals CT based on the first clock signal CLK1 and the second clock signal CLK to provide a temperature data TD for each pixel. The first clock signal CLK1 and the second clock signal CLK2 can represent the position of the each pixel. The interpolator 630 can receive position information for each pixel based on the first clock signal CLK1 and the second clock signal CLK2 for counting each position of the pixels. The interpolator 630 can calculate the temperature data TD for each pixel by interpolating the temperature data TD of the reference pixels PX1˜PX9 based on the position information.

The compensation coefficient calculator 640 can calculate a compensation coefficient CC used for compensating the image data RGB based on the temperature data TD. The data converter 650 can convert the image data RGB to the data signal on a pixel-by-pixel basis, based on the compensation coefficient CC by multiplying a luminance of the image data RGB by the compensation coefficient CC on a pixel-by-pixel basis to generate the data signal DTA.

The interpolator 630 can generate the temperature data TD for each pixel based the relative distances of the pixels in each of display regions from reference pixels defining each of the display regions as described with reference to FIG. 5. The interpolator 630 can provide the temperature data TD for each pixel by interpolating the temperature data TD of each of the reference pixels defining each of the display regions based on the relative distances.

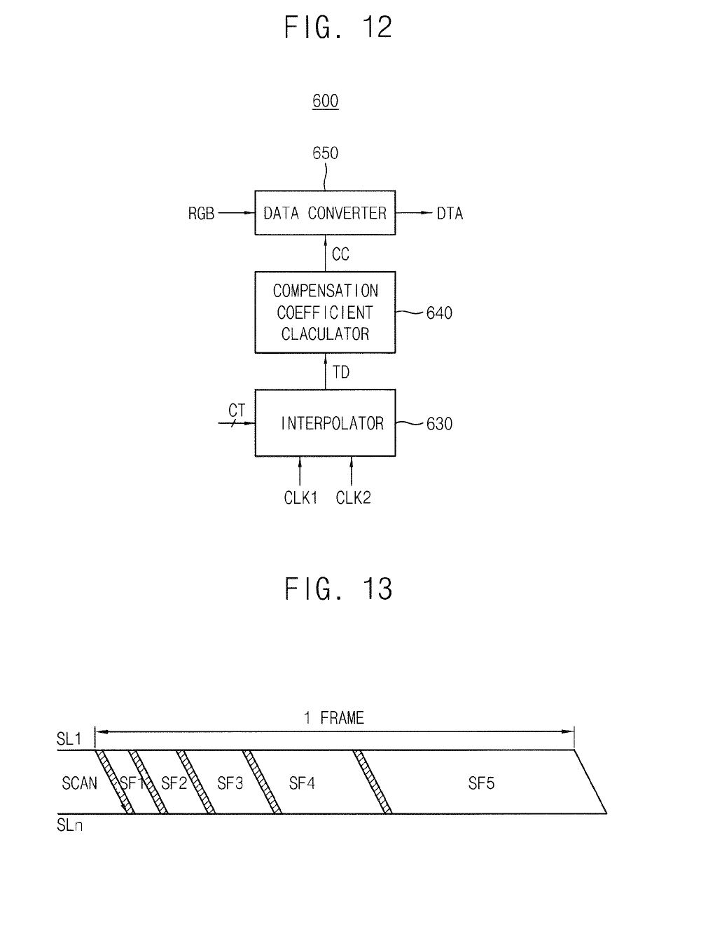

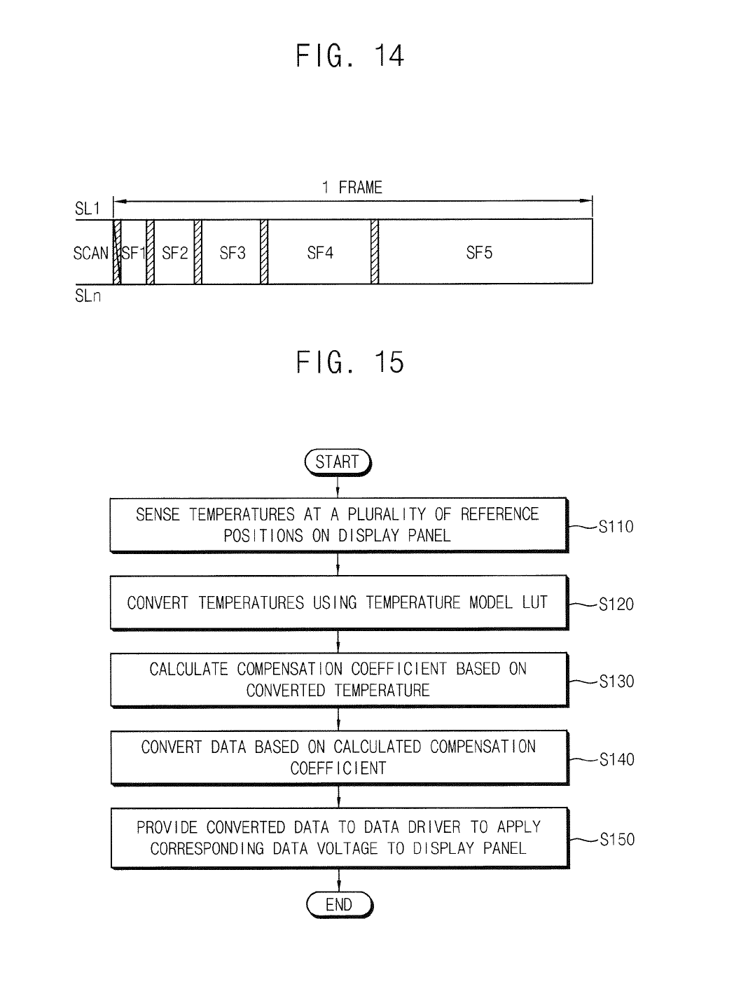

FIG. 13 is a diagram for describing an example of the operation of the OLED display of FIG. 3. FIG. 14 is a diagram for describing another example of the operation of the OLED display of FIG. 3.

Referring to FIGS. 3, 13 and 14, the OLED display 200 can drive the pixels PX using a digital driving technique by adjusting a light emitting period. For example, one frame can be divided into a plurality of sub-frames SF1, SF2, SF3, SF4 and SF5 and each sub-frame can includes a scan period (shown with oblique lines in FIGS. 13 and 14) and a light emitting period. To represent a gray level, each pixel PX can store a data signal during the scan period of each sub-frame and can selectively emit light according to the stored data signal during the light emitting period of each sub-frame.

In some example embodiments, as illustrated in FIG. 13, the pixels PX sequentially emit light on a scan line basis. For example, after the pixels PX connected to a first scan line SL1 are scanned, the pixels PX connected to the first scan line SL1 emit light while the pixels PX connected to a second scan line SL2 are scanned.

In other example embodiments, as illustrated in FIG. 14, the pixels PX can substantially simultaneously emit light. For example, after all the pixels PX connected to the first scan line SL1 through an n-th scan line SLn are scanned, all the pixels PX substantially simultaneously emit light. For example, the high power supply voltage ELVDD can have a low voltage level during the scan period of each sub-frame and then can transition from the low voltage level to a high voltage level to initiate the light emitting period of each sub-frame. In other examples, the low power supply voltage ELVSS can have a high voltage level during the scan period of each sub-frame and then can transition from the high voltage level to a low voltage level to initiate the light emitting period of each sub-frame. This simultaneous light emitting method can be usefully applied when the OLED display 200 displays a stereoscopic image.

FIG. 15 is a flow chart illustrating a method of driving data in an OLED display according to example embodiments.

Hereinafter, there will be description on a method of driving data in an OLED display with reference to FIGS. 3 through 9 and 15.

Referring to FIGS. 3 through 9 and 15, sensed temperature signals ST are generated by sensing temperatures at a plurality of reference positions on a display panel 250 using temperature sensors (S250). The display panel 250 includes a front surface 260 and a rear surface 270 opposing the front surface 260. A plurality of pixels PX are arranged on the front surface 260. The temperature sensors TS are arranged on the rear surface 270. The temperature sensors TS are arranged at positions corresponding to reference pixels of the pixels PX. The sensed temperature signals ST are converted to converted temperature signals CT using the temperature model LUT 310 that nonlinearly maps the sensed temperature signals ST into the converted temperature signals CT (S120). A compensation coefficient CC is calculated in the data compensation circuit 300 based on the converted temperature signals CT (S130). Image data RGB from the AP 100 is converted to a data signal DTA based on the converted temperature signals CT in the data compensation circuit 300 (S140). The converted data signal DTA is applied to the data driver 220 such that data voltages corresponding to the data signal are output to the display panel 250 (S150).

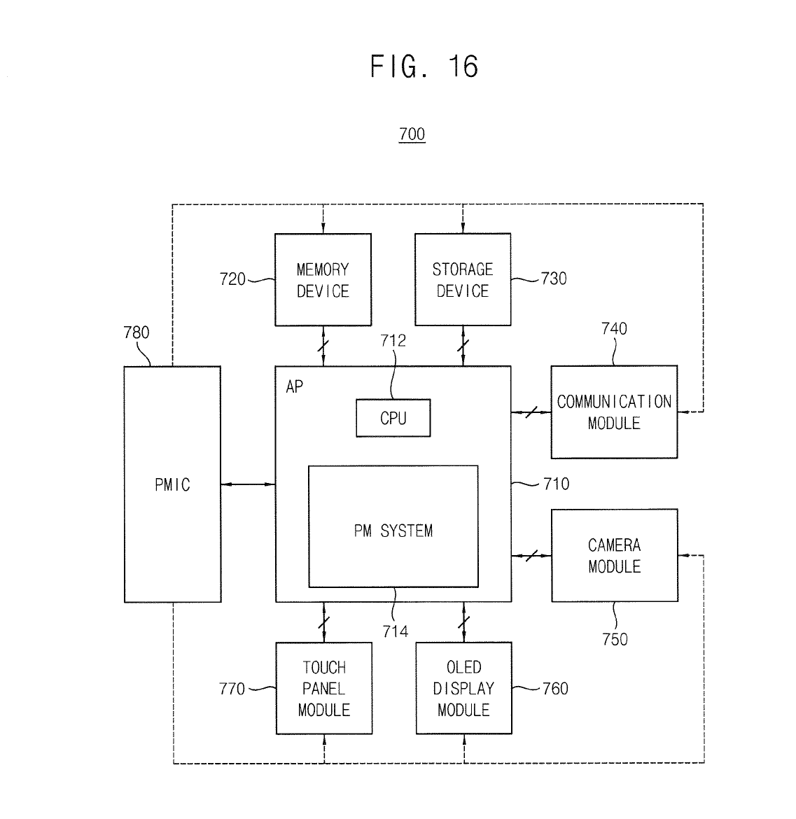

FIG. 16 is a block diagram illustrating a mobile device according to example embodiments.

Referring to FIG. 16, the mobile device 700 includes an AP 710 and a plurality of functional modules 740, 750, 760, and 770. The mobile device 700 further includes a memory device 720, a storage device 730 and a power management integrated circuit (PMIC) 780.

The AP 710 controls the overall operations of the mobile device 700. The AP 710 can control the memory device 720, the storage device 730, and the functional modules 740, 750, 760, and 770. For example, the AP 710 may be a system on chip. The AP 710 includes a CPU 712 and a power management (PM) system 714.

The memory device 720 and the storage device 730 can store data for the operations of the mobile device 700. The memory device 720 may be a volatile semiconductor memory device such as a dynamic random access memory (DRAM) device, a static random access memory (SRAM) device, a mobile DRAM, etc. In addition, the storage device 730 may be a non-volatile semiconductor memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano-floating gate memory (NFGM) device, a polymer random access memory (PoRAM) device, a magnetic random access memory (MRAM) device, a ferroelectric random access memory (FRAM) device, etc. In some embodiments, the storage device 730 may be a solid state drive (SSD) device, a hard disk drive (HDD) device, a CD-ROM device, etc.

The functional modules 740, 750, 760, and 770 perform various functions of the mobile device 700. For example, the mobile device 700 includes a communication module 740 that performs a communication function (e.g., a code division multiple access (CDMA) module, a long term evolution (LTE) module, a radio frequency (RF) module, an ultra-wideband (UWB) module, a wireless local area network (WLAN) module, a worldwide interoperability for a microwave access (WIMAX) module, etc.), a camera module 750 that performs a camera function, an OLED display module 760 that performs a display function, a touch panel module 770 that performs a touch sensing function, etc. In some embodiments, the mobile device 700 further includes a global positioning system (GPS) module, a microphone (MIC) module, a speaker module, a gyroscope module, etc. However, the types of the functional modules 740, 750, 760, and 770 in the mobile device 700 are not limited thereto.

The PMIC 780 can respectively provide driving voltages to the AP 710, the memory device 720 and the functional modules 740, 750, 760 and 770.

According to example embodiments, the OLED display module 760 includes a display panel and a timing controller. The display panel includes a front surface and a rear surface opposing the front surface, a plurality of pixels are arranged on the front surface, a plurality of temperature sensors are arranged on the rear surface and the temperature sensors are arranged at positions corresponding to the reference pixels of the pixels. The timing controller includes a data compensation circuit. The data compensation circuit can convert sensed temperature signals from the temperature sensors using a temperature model LUT, calculate a compensation coefficient based on the converted temperature signals and compensate image data based on the calculated compensation coefficient to provide the data signal. The temperature model LUT can nonlinearly map the sensed temperature signals to the converted temperature signals. Therefore, data compensation can be accurately performed according to changes of temperature of the display panel.

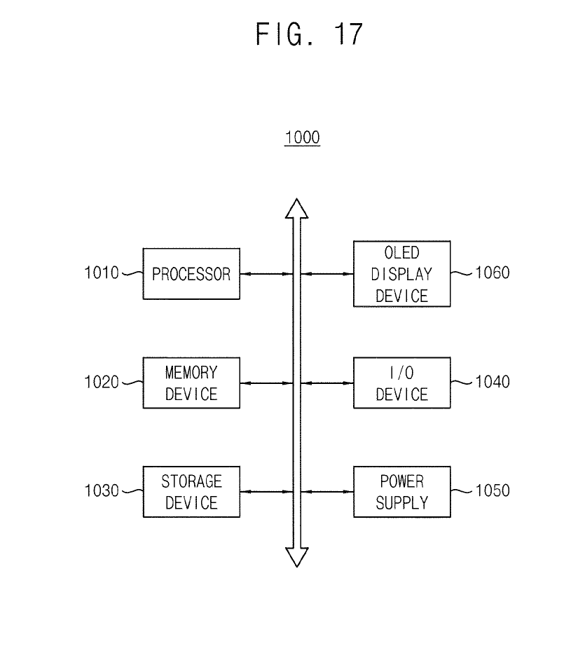

FIG. 17 is a block diagram illustrating an electronic system including an OLED display according to example embodiments.

Referring to FIG. 17, the electronic system 1000 includes a processor 1010, a memory device 1020, a storage device 1030, an input/output (I/O) device 1040, a power supply 1050, and an OLED display 1060. The electronic system 1000 may further include a plurality of ports for communicating a video card, a sound card, a memory card, a universal serial bus (USB) device, other electronic systems, etc.

The processor 1010 can perform various computing functions or tasks. The processor 1010 may be for example, a microprocessor, a central processing unit (CPU), etc. The processor 1010 can be connected to other components via an address bus, a control bus, a data bus, etc. Further, the processor 1010 can be connected to an extended bus such as a peripheral component interconnection (PCI) bus.

The memory device 1020 can store data for operations of the electronic system 1000. For example, the memory device 1020 can include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano-floating gate memory (NFGM) device, a polymer random access memory (PoRAM) device, a magnetic random access memory (MRAM) device, a ferroelectric random access memory (FRAM) device, etc., and/or at least one volatile memory device such as a dynamic random access memory (DRAM) device, a static random access memory (SRAM) device, a mobile dynamic random access memory (mobile DRAM) device, etc.

The storage device 1030 may be, for example, a solid state drive (SSD) device, a hard disk drive (HDD) device, a CD-ROM device, etc. The I/O device 1040 may be, for example, an input device such as a keyboard, a keypad, a mouse, a touch screen, etc., and/or an output device such as a printer, a speaker, etc. The power supply 1050 can supply power for operations of the electronic system 1000. The OLED display 1060 can communicate with other components via the buses or other communication links.

The OLED display 1060 can employ the OLED display 200 of FIG. 3. The OLED display 1060 can include a display panel and a timing controller. The display panel can include a front surface and a rear surface opposed to the front surface, a plurality of pixels are arranged on the front surface, a plurality of temperature sensors are arranged on the rear surface and the temperature sensors are arranged at positions corresponding to the reference pixels of the pixels. The timing controller can include a data compensation circuit. The data compensation circuit can convert sensed temperature signals from the temperature sensors using a temperature model LUT, calculate a compensation coefficient based on the converted temperature signals and compensate image data based on the calculated compensation coefficient to provide the data signal. The temperature model LUT can nonlinearly map the sensed temperature signals to the converted temperature signals. Therefore, data compensation can be accurately performed according to changes of temperature of the display panel.

The electronic system 1000 can be any electronic system, such as a television, a computer monitor, a laptop, a digital camera, a cellular phone, a smart phone, a PDA, a portable multimedia player (PMP), an MP3 player, a navigation system, a video phone, etc.

The above described embodiments can be applied to various kinds of devices and systems such as a mobile phone, a smart phone, a tablet computer, a laptop computer, a PDA, a portable multimedia player (PMP), a digital television, a digital camera, a portable game console, a music player, a camcorder, a video player, a navigation system, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the inventive technology. Accordingly, all such modifications are intended to be included within the scope of the invention as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. An organic light-emitting diode (OLED) display, comprising:
a display panel including a front surface and a rear surface opposing the front surface, wherein the display panel further includes: i) a plurality of pixels arranged on the front surface, ii) a plurality of temperature sensors arranged on the rear surface and iii) a plurality of data lines electrically connected to the pixels, wherein the pixels include a plurality of reference pixels, wherein the temperature sensors are respectively formed at positions corresponding to the reference pixels and wherein the temperature sensors are configured to: i) sense a plurality of temperatures and ii) output a plurality of sensed temperature signals indicative of the sensed temperatures;
a data driver configured to output data voltages to the data lines, wherein the data voltages correspond to a data signal; and
a timing controller comprising a memory configured to store a temperature model look-up table (LUT),
wherein the timing controller is configured to: i) control the data driver, ii) convert the sensed temperature signals using the temperature model LUT, iii) calculate at least one compensation coefficient based on the converted temperature signals and iv) compensate image data based on the calculated compensation coefficient so as to generate the data signal, and
wherein the temperature model LUT is configured to nonlinearly map the sensed temperature signals to the converted temperature signals.

2. The OLED display of claim 1, wherein the display panel further comprises a plurality of scan lines electrically connected to the pixels, wherein the OLED display further comprises:
a scan driver configured to sequentially output a plurality of scan signals to the scan lines; and
a power supply configured to provide the display panel with a high power supply voltage and a low power supply voltage,
wherein the timing controller is further configured to control the scan driver and the power supply.

3. The OLED display of claim 2, wherein each of the pixels comprises:
a switching transistor including: i) a first terminal electrically connected to a corresponding one of the data lines, ii) a gate terminal electrically connected to a corresponding one of the scan lines, and iii) a second terminal electrically connected to a first node;
a storage capacitor electrically connected between the high power supply voltage and the first node;
a driving transistor including: i) a first terminal electrically connected to the high power supply voltage, ii) a gate terminal electrically connected to the first node and iii) a second terminal; and
an OLED electrically connected between the second terminal of the driving transistor and the lower power supply voltage.

4. The OLED display of claim 1, wherein the timing controller comprises a data compensation circuit configured to convert the image data into the data signal based on the sensed temperature signals.

5. The OLED display of claim 4, wherein the data compensation circuit comprises:
the memory;
a temperature converter configured to convert the sensed temperature signals into the converted temperature signals based on the temperature model LUT;
an interpolator configured to interpolate the converted temperature signals based on a first clock signal and a second clock signal so as to generate a temperature data for each of the pixels, wherein the first clock signal and the second clock signal represent the positions of the pixels;
a compensation coefficient calculator configured to calculate the compensation coefficient based on the temperature data; and
a data converter configured to convert the image data into the data signal based on the compensation coefficient.

6. The OLED display of claim 5, wherein when the temperature model LUT does not include a first one of the sensed temperature signals, the temperature converter is configured to interpolate the first sensed temperatures signal based on two sensed temperature signals that are in the temperature model LUT so as to generate a first converted temperature signal, wherein the two sensed temperature signals are adjacent to the first sensed temperature signal.

7. The OLED display of claim 5, wherein the front surface is divided into a plurality of display regions based on the positions of the reference pixels and wherein the interpolator is further configured to calculate the temperature data for a first one of the pixels based on the distances from the first pixel in the corresponding display region to the nearest reference pixels.

8. The OLED display of claim 5, wherein the data converter is further configured to multiply the image data by the compensation coefficient so as to generate the data signal.

9. The OLED display of claim 1, wherein each of the converted temperature signals represents a target luminance of a corresponding one of the pixels for a corresponding one of the sensed temperature signals.

10. The OLED display of claim 1, wherein each of the temperature sensors includes a thermistor that has a negative temperature coefficient.

11. The OLED display of claim 1, wherein the reference pixels comprise:
a first reference pixel electrically connected to a first one of the data lines and a first one of the scan lines;
a second reference pixel electrically connected to a last one of the data lines and the first scan line;
a third reference pixel electrically connected to the first data line and a last one of the scan lines;
a fourth reference pixel electrically connected to the last data line and the last scan line;
a fifth reference pixel electrically connected to the first scan line and arranged at substantially the same distance from each of the first and second reference pixels;
a sixth reference pixel electrically connected to the last scan line and arranged at substantially the same distance from each of the third and fourth reference pixels;
a seventh reference pixel electrically connected to the first data line and arranged at substantially the same distance from each of the first and third reference pixels;
an eighth reference pixel electrically connected to the last data line and arranged at substantially the same distance from each of the second and fourth reference pixels; and
a ninth reference pixel electrically connected to the same data line to which the seventh reference pixel is connected and arranged at substantially the same distance from each of the seventh and eighth reference pixels.

12. A display system, comprising:
a display panel including: i) a front surface and a rear surface opposing the front surface, ii) a plurality of pixels arranged on the front surface and iii) a plurality of temperature sensors arranged on the rear surface, wherein the pixels include a plurality of reference pixels, wherein the temperature sensors are respectively arranged at positions corresponding to the reference pixels and wherein the temperature sensors are configured to: i) sense a plurality of temperatures and ii) output a plurality of sensed temperature signals indicative of the sensed temperatures;
a display driver integrated circuit (DDI) configured to: i) process image data so as to generate a data signal and ii) provide the display panel with a data voltage corresponding to the data signal; and
an application processor comprising a memory storing a temperature model look-up table (LUT), wherein the application processor is configured to: i) provide the DDI with the image data and control signals associated with the image data, ii) convert the sensed temperature signals using the temperature model LUT and iii) provide the converted temperature signals to the DDI,
wherein the temperature model LUT is configured to nonlinearly map the sensed temperature signals to the converted temperature signals.

13. The display system of claim 12, wherein the DDI comprises:
a plurality of data lines electrically connected to the pixels;
a data driver configured to output the data voltage to data lines; and
a timing controller configured to: i) control the data driver, ii) calculate at least one compensation coefficient based on the converted temperature signals and iii) compensate the image data based on the calculated compensation coefficient so as to generate the data signal.

14. The display system of claim 13, wherein the DDI further comprises:
a plurality of scan lines electrically connected to the pixels; and
a power supply configured to supply a high power supply voltage and a low power supply voltage to the pixels,
wherein each of the pixels comprises:
a switching transistor including: i) a first terminal electrically connected to a corresponding one of the data lines, ii) a gate terminal electrically connected to a corresponding one of the scan lines and iii) a second terminal electrically connected to a first node;
a storage capacitor electrically connected between the high power supply voltage and the first node;
a driving transistor including: a first terminal electrically connected to the high power supply voltage, ii) a gate terminal electrically connected to the first node and iii) a second terminal; and
an organic light-emitting diode (OLED) electrically connected between the second terminal of the driving transistor and the lower power supply voltage.

15. The display system of claim 13, wherein the timing controller comprises a data compensation circuit configured to convert the image data to the data signal based on the converted temperature signals and wherein the data compensation circuit comprises:
an interpolator configured to interpolate the converted temperature signals based on a first clock signal and a second clock signal so as to generate a temperature data for each of the pixels, wherein the first clock signal and the second clock signal represent the positions of the pixels;
a compensation coefficient calculator configured to calculate the compensation coefficient based on the temperature data; and
a data converter configured to convert the image data into the data signal based on the compensation coefficient.

16. The display system of claim 15, wherein the data converter is further configured to multiply the image data by the compensation coefficient so as to generate the data signal.

17. The display system of claim 12, wherein the application processor comprises a temperature converter configured to convert the sensed temperature signals into the converted temperature signals based on the temperature model LUT.

18. The display system of claim 12, wherein each of the converted temperature signals represents a target luminance of a corresponding one of the pixels for a corresponding one of the sensed temperature signals.

19. A method of driving an organic light-emitting diode (OLED) display, the method comprising:
sensing temperatures at a plurality of reference positions using a plurality of temperature sensors so as to generate a plurality of temperature signals, wherein the OLED display comprises a display panel including: i) a front surface, ii) a rear surface opposing the front surface, iii) a plurality of pixels arranged on the front surface, iii) the temperature sensors arranged in the rear surface and iv) a data driver;
converting the sensed temperature signals using a temperature model look-up table (LUT), wherein the temperature model LUT is configured to nonlinearly map the sensed temperature signals to the converted temperature signals;
calculating at least one compensation coefficient based on the converted temperature signals;
converting image data to a data signal based on the compensation coefficient; and
the data driver driving the pixels based on the data signal.
